(19) United States
(12) Patent Application Publication
(10) Pub. No.: US 2016/0039129 A1
(43) Pub. Date: Feb. 11, 2016

(54) Plastic Cutlery and Tableware with Interchangeable Elements

(71) Applicant: China Direct International Corporation, Edison, NJ (US)

(72) Inventors: XinQuan Hou, Shanghai (CN); Wei He, Shanghai (CN); William C. Godley, Edison, NJ (US); William A. Gallop, Westminster, MA (US); Ashish Mithal, Chelmsford, MA (US)

(21) Appl. No.: 14/887,978

(22) Filed: Oct. 20, 2015

Related U.S. Application Data
(62) Division of application No. 12/882,841, filed on Sep. 15, 2010, now abandoned.
(60) Provisional application No. 61/247,999, filed on Oct. 2, 2009.

(51) Int. Cl. B29C 45/00; A47G 21/04; B26B 3/02; A47G 21/02

(52) U.S. Cl. CPC B29C 45/006; A47G 21/023; A47G 21/04; B26B 3/02; B29K 2023/12

(57) ABSTRACT

Plastic cutlery and tableware made in at least two parts joinable to form a unitary utensil, serving piece, beverage container or non-food contacting tableware in which the two parts are made of different materials. The materials of the two parts differ in at least one of the following: color, type of plastic, grade of plastic, source of plastic, and additives such as the presence of an anti-microbial agent, transparency, or reflectivity. Food-grade resins, for example, can be used for the heads of cutlery and recycled resins are used for the handles. Heads can be separately metalized and then joined to non-metalized handles. Handles may be made to fit to different types of heads. The two parts of the cutlery may be joined by inserting a tang extending from one into a cavity formed in the other. The two parts of tableware may be joinable by a snap-fit configuration.

### CROSS-REFERENCE TO RELATED APPLICATIONS

The priority benefit of U.S. provisional patent application 61/247,999, filed Oct. 2, 2009, titled “Plastic Cutlery and Tableware with Interchangeable Elements” is claimed and which is incorporated herein in its entirety by reference.

### FIELD OF THE INVENTION

This invention relates to eating utensils and tableware and to the production of expendable eating utensils and tableware for home, restaurant, catering, commercial and institutional use. More particularly, this invention relates to expendable cutlery and tableware with enhanced appearance, lower cost, improved safety and increased structural integrity.

### BACKGROUND OF THE INVENTION

Disposable plastic eating utensils, sometimes referred to as disposable cutlery, are used extensively in restaurants, at home, in institutions, in commercial settings such as on airplanes, and for catered events because of the convenience they provide at a cost that is reasonably low to permit disposal after a single use. Currently, there are many types of disposable plastic cutlery ranging from barely functional inexpensive light-weight plastic cutlery to relatively expensive but higher-quality and more attractive cutlery styles.

Disposable cutlery articles are generally regarded as having a less-than-classic appearance which is not suited for an upscale presentation, while permanent cutlery, that is, metal cutlery is generally regarded as more upscale and as having a superior image but is, practically speaking too expensive to be disposable after a single use. This difference in perception is not entirely due to the superior strength of permanent cutlery. Although stainless steel cutlery or permanent cutlery is indeed stronger than disposable plastic cutlery, heavyweight plastic cutlery is functionally adequate for most occasions and may, after washing, even be reused. It is, therefore, still low enough in cost to be considered non-permanent but, rather, expendable in the sense of reusable for a limited time or a limited number of washings rather than disposable after a single use. Thus, a primary obstacle to the use of disposable plastic cutlery in upscale situations is the perception and the image associated with disposable plastic cutlery rather than its actual performance.

One approach to enhancing the appeal of disposable plastic cutlery is to metalizing it. Metalized cutlery is described in U.S. Pat. No. 6,983,542 C1 (Pat. '542) and US Patent Publications 2006/0191145 (Pub. '145) and 2010/0192388 (Pub. '388), all of which are incorporated in their entirety by reference herein for all purposes. These publications inter alia describe metalized plastic cutlery that replicates the appearance of genuine stainless steel cutlery.

However, there still remains a growing demand for even more attractive, yet sanitary, disposable cutlery.

The traditional method of producing plastic cutlery uses injection-molding to produce a “one-piece” design which inherently limits the choices to the number of such different designs a manufacturer is willing to make.

One prior art teaching by Fisher et al., US Publication No. 2009/019709, which is incorporated herein in its entirety by reference, describes two-part cutlery in which the handled part has a different design on each of its two opposing surfaces so that the user can select one of the two designs simply by rotating the handle. This approach is at best a novelty.

Thus, prior art disposable plastic cutlery is inherently barred from the range of styles and the upscale look of permanent cutlery because of constraints on its price for one-time use. Nonetheless, there is a need to find ways to improve the appearance and increase the range of styles of disposable plastic cutlery while preserving its low cost and the convenience of its ready disposability, yet improve its appearance and strength. These and other needs as shall hereinafter appear are addressed by the cutlery of the present invention.

### SUMMARY OF THE INVENTION

Briefly recited, the present invention describes plastic cutlery and tableware made of two or more parts joined together. Each part is made of a different material and may have a different treatment to give it different set of characteristics of appearance, cost, composition or treatment from the other part. The differences between the parts can include one or more of the following: different type of plastic, different grade of plastic, different source of plastic, different color of plastic, or different reflectivity or transparency of plastic. The differences may reduce cost over one-piece construction but will increase the number of potential choices for the appearance and performance of the cutlery and tableware.

The term “plastic” means a material that may be fixed in a desired shape by molding using, for example, chemical means or ultraviolet light to set the plastic in the shape of the mold. The plastic may be a resin and in particular a synthetic resin either based on petrochemicals or other biological materials such as cellulose, soybeans or agricultural by-products, all of which are often polymerized on cooling and may thus be formed in the desired shape by using injection-molding from resin particles or beads. The shaped plastic must be sufficiently rigid for use as cutlery and tableware and may derive its strength inherently or when augmented by the configuration into which it is molded, that is, with ribs and beads for stiffening of hollowed areas, or by the use of fibers such as hemp or such as new or recycled carbon fibers. The plastic must also be capable of pigmentation in a variety of colors, texturization, and be non-toxic and able to incorporate additives. The plastic is also ideally inexpensive and readily available in large quantities.

As an example of the present invention, in a cutlery set that includes three utensils, namely, a knife, fork and spoon, each utensil of cutlery in the set has a first part that is food contacting, namely, the blade of the knife, the tines of the fork or the bowl of the spoon, and a second part that is not food contacting, namely, the handle. The first and second parts are formed to be mutually complementary so that they may be joined together securely to form a complete utensil for use. Moreover, any first part may be joined to any second part so that, for example, any handle may be joined to the knife blade, the fork tines or the spoon bowl, for example. Alternatively, the cutlery set may include three utensils with three parts each, namely the food contacting first part, a handle second part and a collar third part that the first and second parts join to the collar from its opposing sides.

As another example, if the tableware is a wine glass, it may have a first part that is food contacting first part, namely, a vessel, and two non-food contacting parts, namely, a stem and a base, that are joined together and to the first part to support it and form with it a disposable plastic wine glass. If the tableware is a dinner plate, it may have first part that is the central, food-contacting portion of the plate and a second portion that is a decorative ring that surrounds and is joinable to the central first part to form a complete plate.

As still another example, the first part of a cutlery set can be sprayed-coated with or co-extruded with an outer layer impregnated with an anti-microbial agent such as triclosan, the primary ingredient of MICROBAN, which is a trademark of Mircoban International for a broad spectrum anti-microbial agent. The first part can be individually wrapped and provided with a separate handle for the user to put together, perhaps as part of a catered meal package.

As still another example, a manufacturer can produce seasonal or holiday cutlery with the second part, or handle, available in a color and carrying designs appropriate for the season or holiday. First parts can be manufactured the year round and matched to the appropriate handles that are manufactured only when an order is received. Overall, there would be reduced waste from unsold goods as unsold first parts can be attached to different handles for the next season or holiday.

Because of the use of two or more parts for plastic cutlery and tableware, there is then flexibility in the choice of materials and treatments for the two parts. The first or food-contacting part may be made with food grade resins and the second or non-food-contacting part may be made of low-cost non-food-contacting resins from other sources such as recycled resins. The resulting, joined parts constitute plastic cutlery and tableware having the appropriate source of plastic for the food-contacting part, but are lower in cost that if the entire cutlery or tableware item were made of food grade plastic. If made of recycled plastics, the present invention increases the market for recycling of plastics.

In addition, the first or the second part or both may be characterized by different aesthetic characteristics. For example, the first part of cutlery or any one of the parts of the wine glass described above may be metalized and the remaining part injection-molded in an attractive color or made of clear polystyrene.

Also important, manufacturing cutlery and tableware in parts allows efficiencies that manufacturing of cutlery and tableware as one-piece items does not permit. Metalizing only one part of cutlery, for example, means that greater throughput can be achieved in a vacuum deposition chamber of given size and with less energy than when the whole of one-piece cutlery is metalized.

Importantly, some portions of tableware and cutlery are more vulnerable to breakage than others, for example, the stem of a wine glass or the area between the heads and the handles of cutlery. By separating the cutlery at that vulnerable area and thereby placing a joint there, the joining configuration can provide additional strength at that otherwise weak point and thus reduce breakage. In the case of a wine glass, not only does defining the glass into three components facilitate shipping but the stem part can be made with fiber reinforcement, such as recycled carbon fibers and the configuration of the joints to the vessel and the base can be made made stronger as well. Finally, the base can be made of polypropylene which has a higher coefficient of friction and is less likely to slide on a smooth surface than other plastics. Thus the cutlery and tableware, by segmenting judiciously and by carefully selecting joint configurations and plastics, can result in not only more flexibility in the appearance of the cutlery and tableware but better cutlery and tableware.

Finally, segmenting the design of cutlery and tableware into parts for dramatically increasing manufacturing and aesthetic design flexibility opens opportunities for plastic cutlery and tableware beyond the prior art low-cost disposable cutlery. This flexibility results in a range of qualities and appearances. Currently, the gap between the appearance and cost of low-cost disposable prior art plastic cutlery, for example, and presentable permanent cutlery is vast. There is a long-felt need for cutlery that fills this gap. The present invention can yield plastic cutlery of an appearance and durability that it is expendable rather than disposable, that is, both attractive and substantial enough to be used more than once rather than be disposed of after one use but not so dear that loss or breakage is to be regretted. Such plastic cutlery may be easily preferable not only to low cost disposable plastic cutlery but also to the low end of permanent cutlery. For example, using permanent cutlery for picnics or large catered events may be unwise while expendable plastic cutlery of an attractive appearance and strength may satisfy these occasions far better.

There are numerous advantages of the present invention. Molding simple, inexpensive, disposable cutlery and tableware in separate parts that are then joinable is counterintuitive, as it adds an additional step in manufacturing, namely, joining the two parts, and adds the complications associated with molding the joint configurations used to join and hold the two parts together with what would presumably require relatively tight tolerances. However, off-setting these disadvantages are significant and non-obvious advantages. First of all, the present invention greatly increased flexibility in producing products that provide a much wider range of cutlery and tableware styles and colors. Furthermore, the present invention also enables savings by permitting use of recycled plastics for non-food-contacting parts and that enable more expensive aesthetic treatments such as metallization or the addition of anti-microbial agents to only part of the cutlery and tableware rather than to the whole of the cutlery.

Because the designs of second parts (that is, handles) are separate from the designs of first parts (that is, the blades of knives, tines of forks and bowls of spoons), there is a commercial incentive and an opportunity to produce additional designs for the handles that appeal to relatively fewer customers or for special purposes or events rather than one or two generic designs that have only general appeal. Designs can be generated for the occasion by theme, style, treatment or color and combinations of these.

By injection-molding handles of non-food-grade resins, a greater range of pigments is available to the manufacturer and at lower cost than if the handles are also limited to food-grade resins. In addition the present invention allows the manufacturer to use recycled or recovered resin grades for non-food contact portions of the disposable articles. As a result, the present invention makes good use of recycled materials.

In addition to the above features and advantages, the joint configuration is constructed to be the same for all cutlery heads and handles so that handles can be interchanged among forks, knives and spoons, and different styles of handles can be joined to different heads. As a result, disposable plastic cutlery can be customized for each customer by selecting a handle color and style from a large selection of handle colors and styles and combining it with a choice of a head style from a wide selection of head styles, including metalized heads.

These and other features and their advantages will be readily apparent to those skilled in the art of manufacturing cutlery from a careful reading of the Detailed Description of Preferred embodiments, accompanied by the following drawings.

### BRIEF DESCRIPTION OF THE DRAWINGS

In the drawings:

FIG. 1. shows a set of cutlery including a spoon, knife and fork as an embodiment of the present invention;

FIG. 2 shows the knife from FIG. 1 with the tang shown in phantom lines;

FIG. 2A is a cross-sectional view of the knife of FIG. 2 taken along line 2A-2A of FIG. 2;

FIG. 2B is a cross-sectional view of the knife of FIG. 2 taken along line 2B-2B of FIG. 2;

FIG. 2C is a cross-sectional view of the knife of FIG. 2 taken along line 2C-2C of FIG. 2;

FIG. 3 is a detailed, exploded view of the joint of the knife of FIG. 2;

FIG. 4A is a perspective view of a fork as an embodiment of the present invention with the head removed from the handle, the tang having longitudinal ridges which increase frictional gripping of the tang by the handle;

FIG. 4B is a magnified perspective view of the tang and the cavity of FIG. 4A;

FIG. 4C is an end view of the tang of FIG. 4B;

FIG. 4D is a side view of the fork of FIG. 4A;

FIG. 4E is a top view of the fork of FIG. 4A;

FIG. 5A is a perspective view of a fork as an embodiment of the present invention with the head removed from the handle, the tang having a pair of longitudinal rails which increase frictional gripping of the tang by the handle;

FIG. 5B is a magnified perspective view of the tang and the cavity of FIG. 5A;

FIG. 5C is a more strongly magnified perspective view of the tang and the cavity of FIG. 5A;

FIG. 5D is an end view of the tang of FIG. 5B;

FIG. 5E is a side view of the fork of FIG. 5A;

FIG. 5F is a top view of the fork of FIG. 5A;

FIG. 6A is a perspective view of a fork as an embodiment of the present invention with the head removed from the handle, the tang having side barbs which increase frictional gripping of the tang by the handle and/or engage with compatible structures and/or with deformable warm plastic in the cavity of the handle;

FIG. 6B is a magnified perspective view of the tang and the cavity of FIG. 6A;

FIG. 6C is a side view of the fork of FIG. 6A;

FIG. 6D is a magnified side view of the tang of FIG. 6C;

FIG. 6E is a top view of the fork of FIG. 6A;

FIG. 7A is a perspective view of a fork as an embodiment of the present invention with the head removed from the handle, the tang having a pair of T-hooks which engage with compatible recesses and/or with deformable warm plastic in the cavity of the handle;

FIG. 7B is a magnified perspective view of the tang and the cavity of FIG. 7A;

FIG. 7C is a side view of the fork of FIG. 7A;

FIG. 7D is a top view of the fork of FIG. 7A;

FIG. 8A is a perspective view of a fork as an embodiment of the present invention with the head removed from the handle, the tang having an L-hook which engages with compatible recesses and/or with deformable warm plastic in the cavity of the handle;

FIG. 8B is a magnified perspective view of the tang and the cavity of FIG. 8A;

FIG. 8C is a side view of the fork of FIG. 8A;

FIG. 8D is a magnified perspective view of the tang and the cavity of FIG. 8C;

FIG. 8E is a top view of the fork of FIG. 8A;

FIG. 9A is a perspective view of a fork as an embodiment of the present invention with the head removed from the handle, the tang being tapered to a point and having a pair of shoulders and a perforation which engage with compatible features and/or with deformable warm plastic in the cavity of the handle;

FIG. 9B is a magnified perspective view of the tang and the cavity of FIG. 9A;

FIG. 9C is a side view of the fork of FIG. 9A;

FIG. 9D is a top view of the fork of FIG. 9A.

FIG. 10 is a partial cross-sectional view of a coffee mug made according to an embodiment of the present invention;

FIG. 11 is a partial cross-sectional side view of a serving bowl made according to an embodiment of the present invention;

FIG. 12 is a cross section of a candlestick made according to an embodiment of the present invention; and

FIG. 13 is a flow chart of an embodiment of the present invention.

### DETAILED DESCRIPTION OF PREFERRED EMBODIMENTS

The present invention is plastic cutlery and tableware and a method of making same. The term “cutlery” is used herein to refer to eating utensils such as knives, spoons, forks, salad forks, soup spoons, butter knives, steak knives, cocktail forks, serving forks and spoons, tongs, chop sticks, cake cutters, spatulas, ladles, food picks, kitchen utensils, and the like, all of which are characterized by a handle and a head joined to the handle to form a hand tool or implement. The handle is the part grasped by the user. The term “head” in the present context of cutlery is the part opposite and joined to the handle of the cutlery that is configured to be used in the processes of holding, cutting, manipulating, serving, consuming or conveying food and that comes into contact with food in process and/or into contact with the mouth of the user.

The term “tableware” refers to items related to food service other than cutlery such as cups, mugs, goblets, wine glasses, tumblers, champagne flutes, candleholders, napkin rings, serving pieces and decorative items used for table setting purposes which, along with cutlery, comprise a table service set and are also included within the scope of this invention inasmuch as these related items of a table service set may preferably have a consistent appearance. For example, coffee mugs, serving pieces and napkin rings may match cutlery sets in style and color and be sold as a kit. Finally, the appearance of an embodiment illustrated in the drawings is not intended to limit the scope and range of possible designs that can be conceived of according to the present invention and manufactured according to the method of the present invention. Indeed, there are innumerable variations and applications all within the scope of the present invention. To simplify the following description, the term cutlery will be used to refer to both cutlery and tableware unless specifically indicated by the context.

Plastic cutlery is typically injection-molded of either polystyrene and/or polypropylene resins. However, other polymeric resins may be used to make the cutlery of the present invention. Material choices for such applications are more often than not governed by a variety of factors including consumer preferences, cost, engineering requirements, availability, government restrictions, guidelines and requirements, as well as other factors. The material may be an injection-moldable thermosetting resin that when set is sufficiently rigid and strong for the purposes for which it is intended, non-toxic, safe for use, commercially available in sufficient quantities, and both safely and legally disposable. It may be injection-molded in an assortment of colors or be transparent. It may be metalized by vacuum vapor deposition or sputter deposition.

Resins which are useful in the present invention include polypropylene and homopolymers and copolymers of polyvinylchloride. Specific copolymers of vinylchloride include polymerized monomers of acrylate, specifically methacrylate, acrylonitrile, styrene, phenyleneoxide, acrylic acid, maleic anhydride, vinyl alcohol and vinyl acetate.

Plasticizers for use in the present cutlery and tableware may include compounds with low volatility and which have the ability to disperse polymeric resin particles. The plasticizers may facilitate adherence of the polymeric resin to the fibers. Typical plasticizers include normal and branched chain alcoholic esters and glycol esters of various mono-, di- and tri-basic acids, for example esters of phthalic, adipic, sebacic, azelaic, citric, trimellitic (and anhydride) and phosphoric acids; chloro-hydrocarbons; esters of long chain alcohols; liquid polyesters; and epoxidized natural oils, such as linseed and soya oils. Representative phthalate plasticizers include: di-2-ethylhexyl phthalate, n-C6-C8-C10 phthalate, n-C7-C9-C11 phthalate, n-octyl-n-decyl phthalate, ditridecyl phthalate, diisonyl phthalate, diisooctyl phthalate, diisodecyl phthalate, butylbenzylphthalate, dihexyl phthalate, butyl ocytyl phthlate, dicapryl phthalate, di-2-ethylhexyl isophthalate, alkyl benzene phthalates, dimethyl phthalate, dibutyl phthalate, diisobutyl phthalate, butyl isodecyl phthalate, butyl iso-hexyl phthalate, diisononyl phthalate, dioctyl phthalate, hexyl octyl decyl phthalate, didecyl phthalate diisodecyl phthalate, diundecyl phthalate, butyl-ethylhexyl phthalate, butylbenzyl phthalate, octylbenzyl phthalate, dicyclohexyl phthalate, diphenyl phthalate, aklylaryl phthalates, and 2-ethylhexylisodecyl phthalate. Additional plasticizers include: abietic derivatives are suitable such as: hydroabietyl alcohol, methyl abietate and hydrogenated methyl abietate; acetic acid derivatives such as cumylphenylacetate; adipic acid derivatives such as benzyloctyl adipate, dibutyl adipate, diisobutyl adipate, di-octyladipate, di-2-ethylhexyl adipate, diisononyl adipate, diisooctyl adipate, dinonyl adipate, C7-9 linear adipate, dicapryl adipate, octyl decyl adipate (such as n-octyl, n-decyl adipate), straight chain alcohol adipate, didecyl adipate, diisodecyl adipate, dibutoxyethyl adipate, high molecular weight adipate, polypropylene adipate, modified polypropylene adipate; azelaic acid derivatives such as dicyclohexyl azelate, di-2-ethylhexyl azelate, di-n-hexyl azelate, diisooctyl azelate and diisodecyl adipate; benzoic acid derivatives such as diethylene glycol dibenzoate, dipropylene glycol dibenzoate, diethylene glycol benzoate and dipropylene glycol benzoate blend, neopentyl glycol dibenzoate, glyceryl tribenzoate, trimethylolethatane tribenzoate, pentaerythritol tribenzoate, cumylphenylbenzoate; polyphenyl derivatives such as hydrogenated terphenyl; citric acid derivatives, such as triethyl citrate, tri-n-butyl citrate, acetyl triethyl citrate, acetyl tri-n-butyl citrate, acetal tributyl citrate; epoxy derivatives such as butyl epoxy stearate, alkyl epoxy stearate, epoxidized butyl ester, epoxidized octyl tallage, epoxidized triglyceride, epoxidized soybean oil, epoxidized sunflower oil, epoxidized linseed oil, epoxidized tallate ester, 2-ethylhexyl-epoxy tallate, octyl epoxy stearate; ether derivatives such as cumylphenyl benzyl ether; formal derivatives such as butyl carbitol formal; fumaric acid derivatives such as dibutyl fumarate, diisooctyl fumarate, dioctyl fumarate; glutaric acid derivatives such as mixed dialkyl glutarates and dicumylphenyl glutarate; glycol derivatives such as diethylene glycol dipelargonate, triethylene glycol dipelargonate, triethylene glycol di-(2-ethylbutyrate), triethylene glycol di-caprylate-caprate, triethylene glycol di-(2-ethylhexoate), triethylene glycol dicaprylate, tetraethylene glycol dicaprylate, polyethylene glycol di-(2-ethylhexoate), butyl phthalyl butyl glycolate, triglycolester of vegetable oil fatty acid, triethylene glycol ester of fatty acid; linear dibasic acid derivatives such as mixed dibasic ester; petroleum derivatives such as aromatic hydrocarbons; isobutyric acid derivatives such as 2,2,4-trimethyl-,1,3-pentanediol diisobutyrate; isophthalic acid derivatives such as di(2-ethylhexyl)isophthalate, diisooctyl isophthalate, dioctylisophthalate; lauric acid derivatives such as butyllaurate, 1,2-propylene glycol monolaurate, ethylene glycol monoethyl ether laurate, ethylene glycol monobutyl ether laurate, glycerol monolaurate, polyethylene glycol-400-dilaurate; mellitic acid derivatives such as n-octyl, n-decyl trimellitate, tri-n-octyl-n-decyl trimellitate, triisononyl trimellitate, triisooctyl trimellitate, tricapryltrimellitate, diisooctyl monoisodecyl trimellitate, triisodecyl trimellitate, tri(C7-9 alkyl) trimellitate, tri-2-ethylhexyl trimellitate; nitrile derivatives such as fatty acid nitrile; oleic acid derivatives such as butyl bleate, 1,2-propylene glycol mono oleate, ethylene glycol monobutyl ether oleate, tetrahydrofurfuryl oleate, glycerlyl monoleate; paraffin derivatives such as chlorinated paraffins, diethylene glycol dipelargonate, triethylene glycol dipelargonate, 2-butoxyethyl dipelargonate; phenoxy plasticizers such as acetyl paracumyl phenol; phosphoric acid derivatives such as tri-(2-ethylhexyl) phosphate, tributoxyethyl phosphate, triphenyl phosphate, cresyl diphenyl phosphate, tricresyl phosphate, tri-isopropylphenyl phosphate, alkyl aryl phosphates, diphenyl-xylenyl phosphate, phenyl isopropylphenyl phosphate 2-ethylhexyl diphenyl phosphate, and decyl diphenyl phosphate; ricinoleic acid derivatives such as methylacetyl riconoleate, n-butyl acetyl ricinoleate, glyceryl triacetyl ricinoleate; sebacic acid derivatives such as dimethyl sebacate, dibutyl sebacate and dibutoxyethyl sebacatel; stearic acid derivatives such as glyceryl tri-acetoxy stearate, butyl acetoxy stearate, methylpentachlorostearate and methoxyethyl acetoxy stearate; sucrose derivatives such as sucrose benzoate; sulfonic acid derivatives such as alkyl-sulfonic esters of phenol; tall oil derivatives such as methylester of tall oil and isooctyl ester of tall oil; and terephthalic acid derivatives such as dioctyl terephthalate.

The term “reinforcement”, as used herein, refers to reinforcing fibers including metal fibers; glass fibers, such as E-glass, A-glass, C-glass, D-glass, AR-glass, R-glass, S1-glass, S2-glass; basalt fiber, carbon fibers such as graphite; boron fibers; ceramic fibers such as alumina or silica; aramid fibers; synthetic organic fibers such as polyamide, polyethylene, paraphenylene, terephthalamide, polyethylene terephthalate and polyphenylene sulphide; and various other natural or synthetic inorganic or organic fibrous materials known to be useful for reinforcing thermosetting polymeric compositions, such as cellulose, asbestos, cotton, and the like.

Curing of plastics may be accomplished by a variety of techniques known in the art including thermal, photoactivation, and e-beam or other radiation-type curing.

Disposable cutlery is typically made from so-called food-grade resins of polystyrene and/or polypropylene, also referred to herein as food-grade plastics, which are deemed safe for use in food-contact applications. Food-grade resins are typically polymeric resins that are manufactured under rigorous process control and supplied by resin manufacturers as virgin materials. Food-grade resins meet the compliance criteria or test protocols established or promulgated by an appropriate regulatory body such as FDA or CEN which may include no more than threshold amounts of certain volatile organic compounds, toxins and other chemicals. The manufacturer of these food-grade resins often supply quality control and regulatory compliance documentation with each lot of resin material delivered.

However, once the same food-grade resins have been processed and recycled, they no longer carry the same “food-grade” designation and are usually available at much lower prices to manufacturers compared to food-grade or “virgin” resins. There are other sources of non-food grade plastics in addition to recycled plastics and several sources of recycled plastics such as post-consumer plastics, post-manufacturing plastics and scrap plastics. Many non-food grade plastics can be pigmented, formed, textured, carved, and otherwise given an attractive aesthetic appearance and may have qualities of strength and rigidity as well as low cost that make them ideal for handles of cutlery, in conjunction with cutlery heads made using food-grade plastics.

Thus, the present cutlery may be molded from at least two different plastic grades or sources, food-grade and non-food grade, so that in cutlery, for example, only the food-contacting heads are made of food-grade plastics while the handles of the cutlery are made of non-food-grade plastics. In some embodiments, one handle design is used with a plurality of cutlery head shapes. In embodiments where a metallic appearance is desired, the present invention may include metallization of only one part, typically the head, which is then combined with an unmetalized handle, thereby providing the desired permanent-ware appearance while reducing the cost associated with the metallization. According to another embodiment of the invention, the head remains unmetalized, and perhaps made of a clear plastic, while the handle is metalized. According to still another embodiment of the invention, both the head and handle pieces are metalized from either the same metallic coating or a first metallic coating on the head and a second metallic coating on the handle. Of course, neither of the two parts is necessarily metalized but may be given a suitable appearance through pigments, lack of pigments, textures and performance.

The head and handle parts according to present invention are configured to be joined together to make a whole utensil. The head and handle may be configured to be joined in a reversible fashion allowing subsequent separation and disassembly, perhaps permitting reuse of handles. Alternately the head and handle pieces can be connected permanently. The head and handle portions can be connected by a set of mutually cooperating male and female members wherein the male member is disposed on either the head or the handle with the female member being disposed in the handle or the head, respectively.

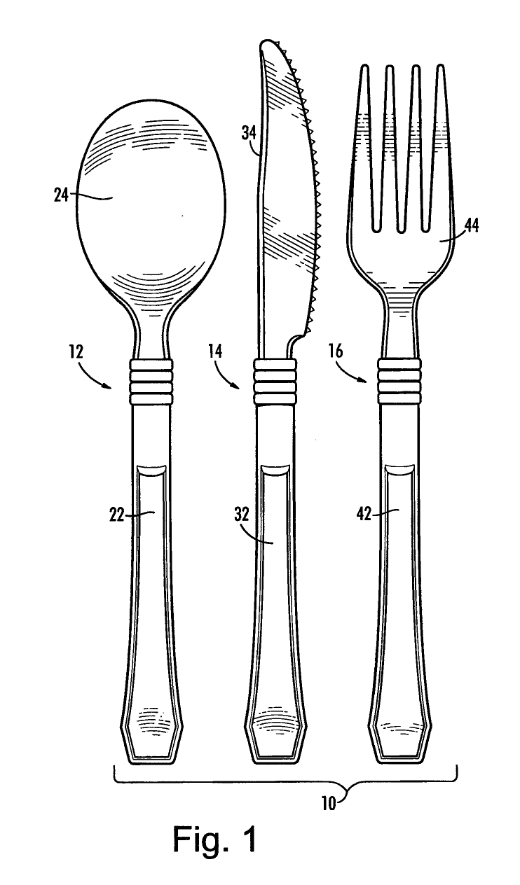

FIG. 1 illustrates a set of cutlery, in an exemplary embodiment of the invention, generally indicated by the reference number 10. Set 10 includes a spoon, 12, a knife 14 and a fork 16. Spoon 12 has a handle 22 and a spoon head 24; knife 14 has a handle 32 and a knife head 34; and fork 16 has a handle 42 and a fork head 44. In the embodiment shown herein, handles 22, 32, 42 are made to be identical. The particular ornamental style of handles 22, 32, 42 is arbitrary. Cutlery may have functional ornamentation, by which is meant that consumers expect ornamentation, however plain or fancy, in cutlery. Functional ornamentation, including the ornamentation shown in the figures, is not a feature of the present invention, only the fact that handles 22, 32, 42 can carry ornamentation ranging from plain to fancy.

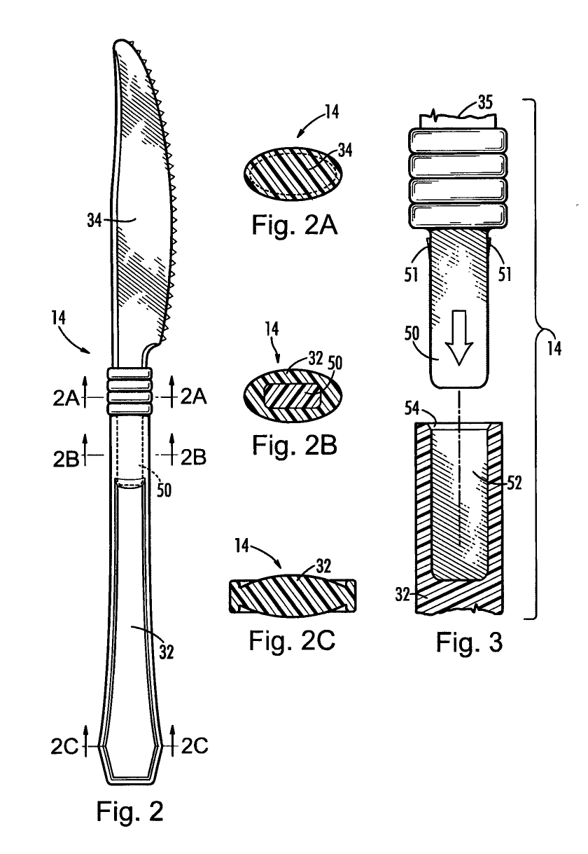

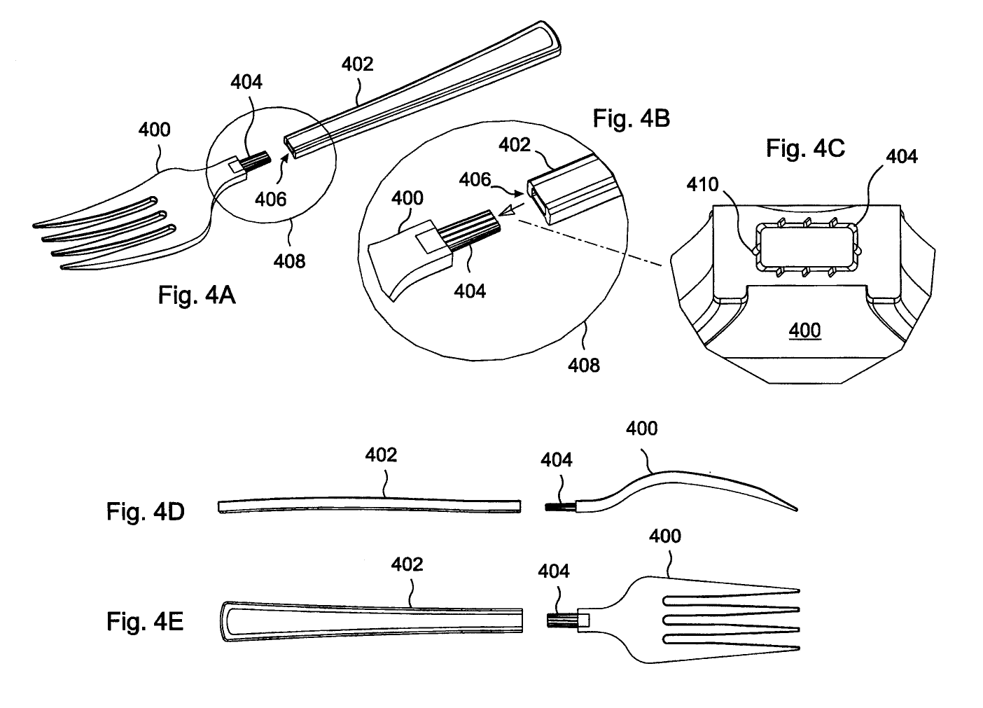

FIG. 2 illustrates knife 14 as shown in set 10. FIGS. 2A-2C illustrate cross sectional views along the major dimension of knife 14. FIG. 3 illustrates an exploded, detailed view of knife 14. FIG. 2 includes a tang 50 shown in phantom lines in handle 32. Tang 50 is an integrally-formed extension of head 34 with friction tabs 51 on opposing sides thereof and that is received within a cavity 52 formed in handle 32. Alternatively, handle 32 may have a tang and head 34 may have a cavity. Other configurations for the interface between handle 32 and head 34 that allow them to form a joint 54 that, with friction tabs 51, holds handle 32 to head 34 securely through normal one-time use are possible, some of which are discussed below in reference to FIGS. 4A through 9D.

In order to increase the strength of the joint 54, tang 50 and cavity 52 can be dimensioned so that tang 50 is very close to the same size as cavity 52, so that tang 50 just fits into cavity 52 when handle 32 is still warm from being molded. Friction tabs 51 increase friction between tang 50 and cavity 52 to help hold tang 50 in cavity 52. As handle 52 cools, it will shrink to grip tang 50 tightly.

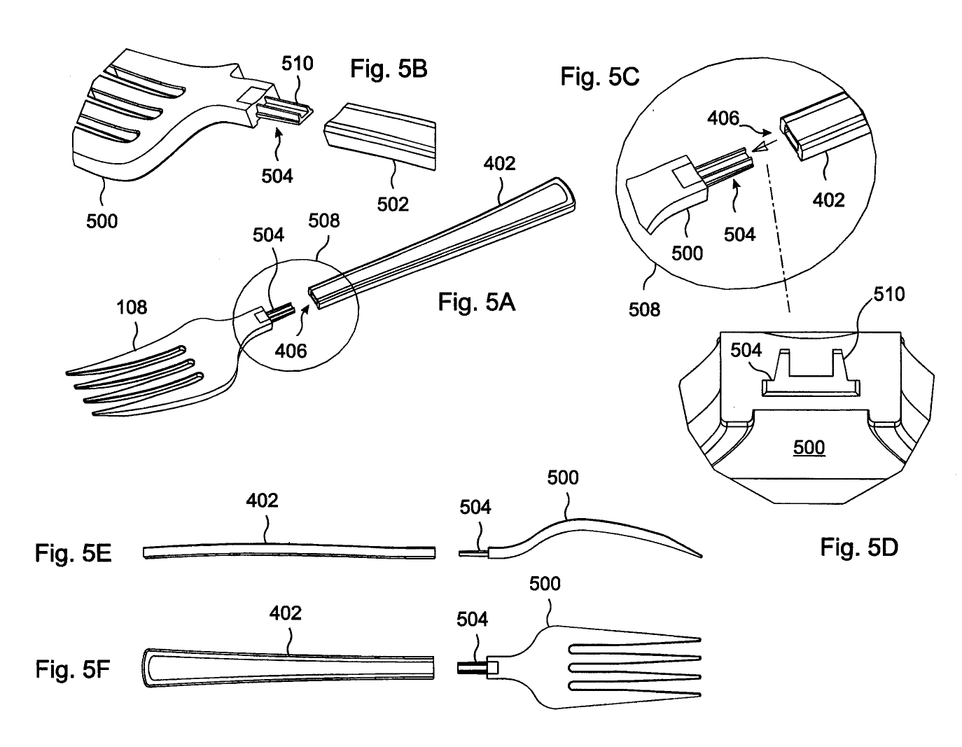

Alternatively, tang 50 may be molded with thin fins, ridges, and/or rails that deform against the walls of cavity 52 as tang 50 is inserted into cavity 52 to increase the frictional fit between tang 50 and cavity 52. For example, in some embodiments the fins (not shown) may be a series of rectangles formed parallel to each other along one side of tang 50 running from the front of handle 32 to the back and extending perpendicular to tang 50. Upon insertion of tang 50 into cavity 52, the fins deform against the sides of tang 50 in a direction opposing the direction of insertion and thereby increasing both the frictional fit and the resistance to removal. Other examples are discussed below with reference to FIG. 4A through 4E and 5A through 5F.

In the embodiment of FIG. 3, cavity 52 has an entrance 54 that is chamfered so that tang 50 can be inserted fully into cavity 52 leaving minimal gap for improved appearance.

Handles 22, 32, 42 may be made by injection-molding of a material that is different from the material used for head 24, 34, 44, respectively. One of many such examples of this embodiment would be handles 22, 32, 42 comprised of a less expensive recycled resin, thus providing more choices in materials, rigidity, color choices and manufacturing cost. Heads 24, 34, 44 are injection-molded of food-grade material. In some embodiments heads 24, 34 and 44 may be metalized; and in some embodiments handles 22, 32 and 42 may be metalized. In some embodiments heads 24, 34 and 44 may be metalized with a first metallic coating and handles 22, 32 and 42 may be metalized with a second metallic coating.

Handles, 22, 32, 42 may be a different color than heads, 24, 34, 44, respectively, providing a variety of color combinations for esthetic purposes including customizing a place setting for a specific customer, event or occasion or for matching other table setting articles such as plates, cups, bowls or other dinnerware items. In some embodiments, handles 22, 32, 42 may be the same size and shape so that they are interchangeable among different heads 24, 34, 44, respectively, so that any handle 22, 32, 42 will fit with any head 24, 34, 44. Handles 22, 32, 42, and heads 24, 34, 44, may be made in a large number of colors and styles but with the same dimension of tang 50 and recess 52 so that any style of handle 22, 32, 42 may be fitted to any style of heads, 24, 34, 44, respectively.

FIGS. 4A through 4E illustrate a fork as an embodiment of the present invention wherein the head 400 and handle 402 are joined by a tang 404 inserted into a cavity 406, the tang 404 including a plurality of parallel, longitudinal ridges 410 distributed on both sides and both edges of the tang 404. As shown in the expanded view of FIG. 4C, the ridges 410 in this embodiment are rectangular with rounded ends, and are sufficiently narrow so as to flatten or deform at least partly against the sides of the tang 404 when the tang 404 is inserted into the cavity 406 and the ridges 410 are pressed against the walls of the cavity 406.

FIGS. 5A through 5F illustrate a fork as an embodiment of the present invention which is similar to FIGS. 4A through 4E, except that the tang 504 includes two parallel rails 510 running along only one side of the tang 504. The rails 510 increase the surface gripping area of the tang 504, and are partially deformed when the tang 504 is inserted into the cavity 406, thereby increasing the frictional grip between the tang 504 and the cavity 406.

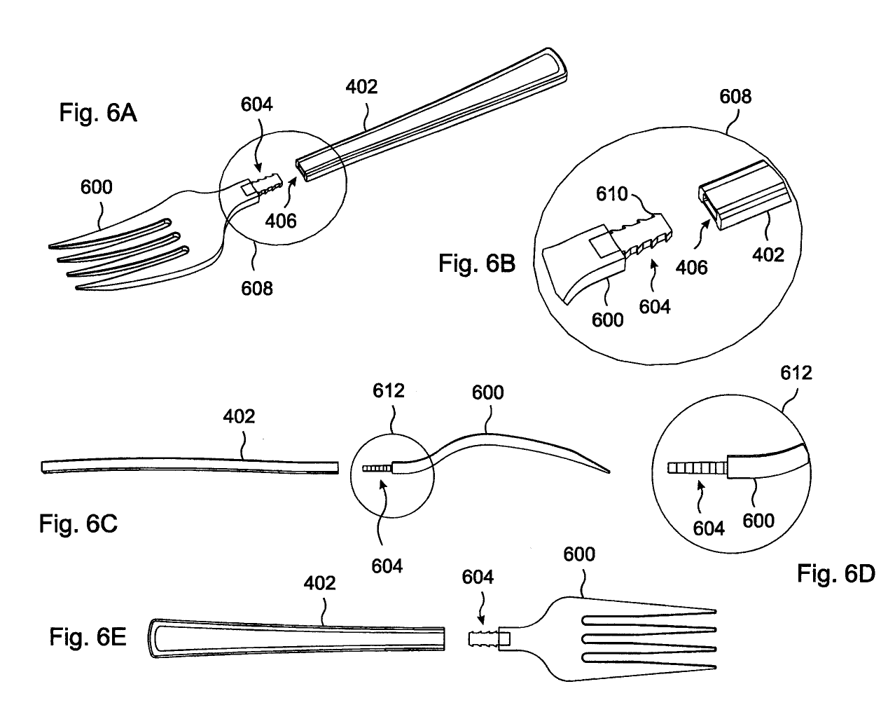

The embodiment of FIGS. 6A through 6E is similar to the two preceding embodiments, except that a row of barbs 610 is provided along each edge of the tang 604. The barbs 610 in this embodiment are approximately triangular, and are oriented along the edges of the tang 604 so as to naturally deform toward the tang 604 when the tang 604 is inserted into the cavity 406, but to extend away from the tang 604 due to friction and thereby oppose withdrawal of the tang 604 from the cavity 406 if such a withdrawal is attempted. In some embodiments, corresponding structures are provided within the cavity 406 which engage with the barbs 610 when the tang 604 is inserted. In other embodiments, the tang 604 is inserted into the cavity 406 when the handle 402 is still warm, so that the soft plastic of the handle 402 surrounds, shrinks down on and hardens around the barbs 610 as the plastic cools, thereby preventing removal of the tang 604 from the cavity 406.

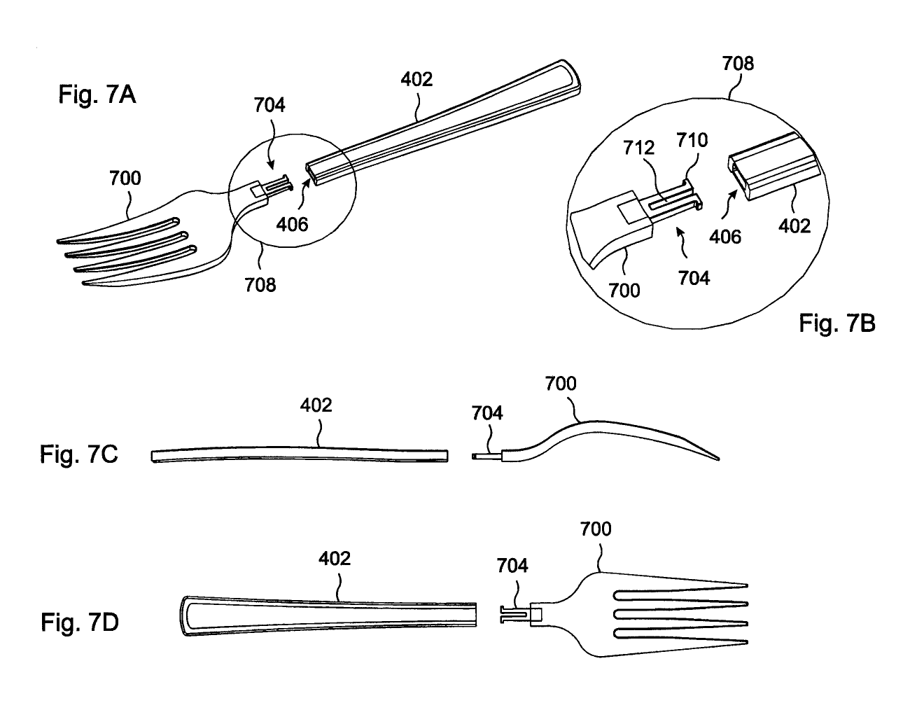

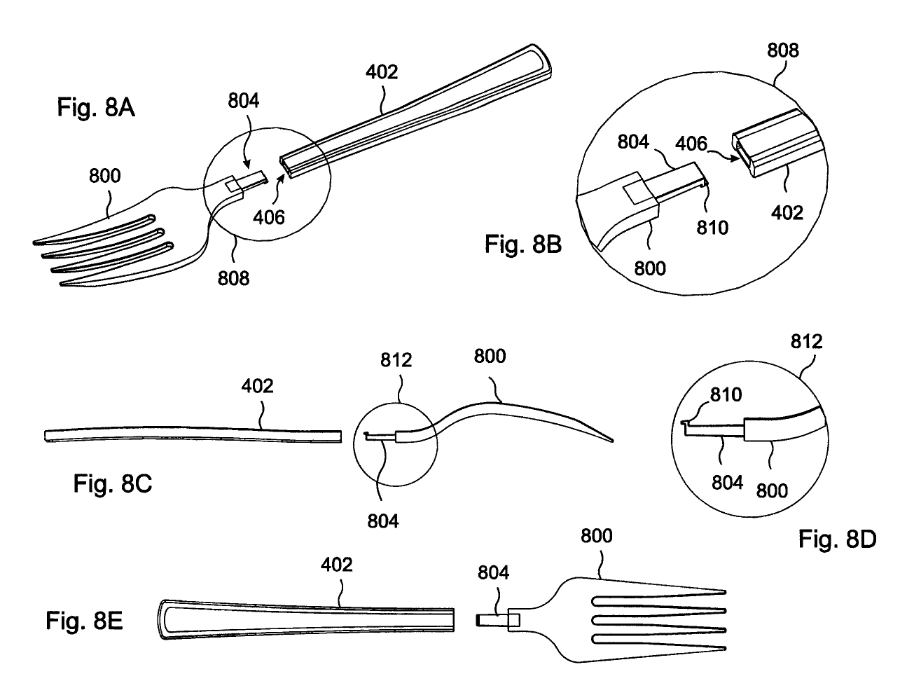

The embodiment of FIGS. 7A thorough 7D is similar to the preceding embodiments, except that it includes a pair of snap fit members 710 at the distal end of the tang 704. The tang also includes a slot 712 in the center of the tang 704, which allows the two snap fit members to temporarily bend inwardly toward each other and allowing the tang 704 to be inserted into the cavity 406. Once inserted, the snap fit members 710 spring outwardly to their original position and provide frictional gripping by pressing against the edges of the cavity 406. In other embodiments, compatible structures within the cavity 406 engage with the snap fit members 710 when the tang 704 is inserted. The embodiment of FIG. 8A thorough 8E is similar to the preceding embodiments, except that it includes a single snap fit 810 at the distal end of the tang 804.

In the embodiment of FIGS. 8A through 8E, snap fit 810 is roughly “Z”-shaped in that it includes a portion at the end which is parallel to the tang 804. In some embodiments, snap fit 810 provides frictional gripping by pressing against a side of the cavity 406. In other embodiments, a compatible structure is provided within the cavity 406 that engages with snap fit 810 when the tang 804 is inserted into the cavity 406. In still other embodiments, the tang 804 is inserted into the cavity 406 when the handle 402 is still warm, so that the soft plastic of the handle 402 surrounds, shrinks down on and hardens around snap fit 810 as the plastic cools, thereby preventing removal of the tang 804 from the cavity 406.

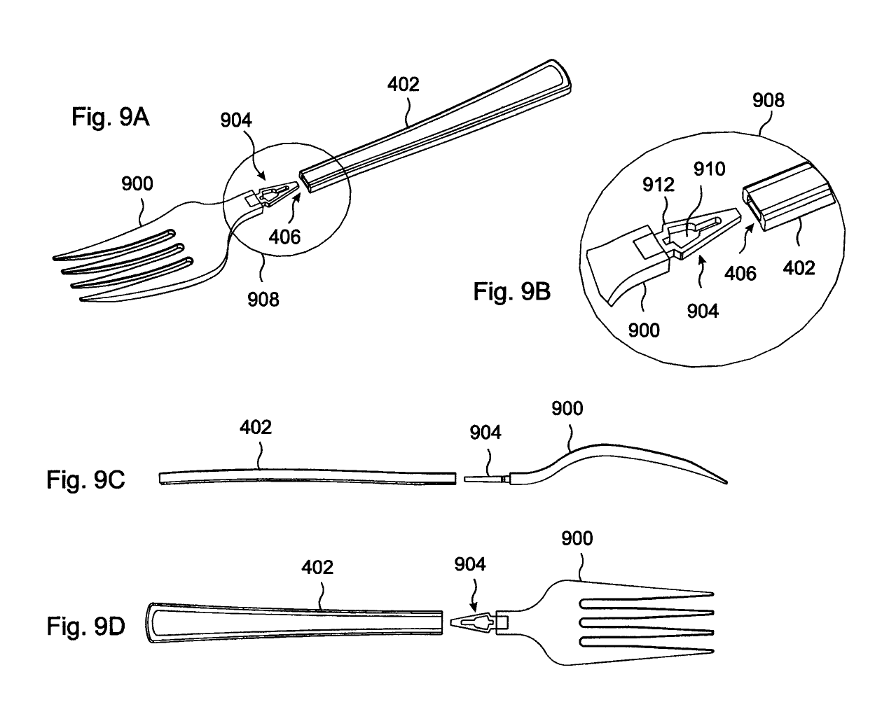

The embodiment of FIG. 9A thorough 9D is similar to the preceding embodiments, except that the tang 904 is shaped approximately like a blunt arrow head, and a large perforation 910 fills the central region of the tang 904. In some embodiments, the tang 904 provides frictional gripping due to pressing of barbs 912 of the “arrowhead” against the edges of the cavity 406. In other embodiments, a compatible structure is provided within the cavity 406 which engages with the barbs 912 and/or the perforation 910 when the tang 904 is inserted into the cavity 406. In still other embodiments, the tang 904 is inserted into the cavity 406 when the handle 402 is still warm, so that the soft plastic of the handle 402 surrounds, shrinks down on and hardens around the tang 904, penetrating into the central perforation 910 and in some embodiments to bridge it. Once the plastic has cooled and hardened, removal of the tang 804 from the cavity 406 is thereby prevented,

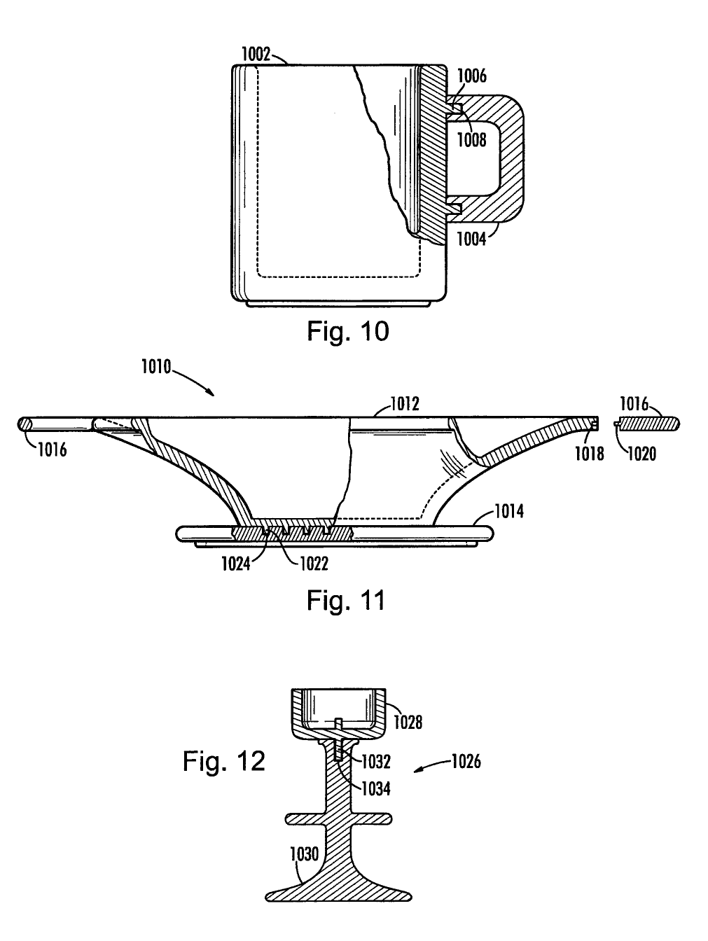

FIG. 10 illustrates a mug 1002 as a first part with a handle 1004 as a second part. Mug 1002 and handle 1004 are shown in partial cross section to show mug 1002 with a projection 1006 that extends into a recess 1008 in handle 1004 so that mug 1002 and handle 1004 can be joined together. Handle 1004 may be made of recycled plastic, for example, in a bold color from a suitable pigment added to the recycled plastic resins that are injection-molded to form handle 1004 or it may be metalized as a subsequent treatment to handle 1004. Mug 1002 may be made of food-grade plastic.

FIG. 11 is a serving dish 1010 composed of a food-contacting bowl 1012, on a flat plate underliner 1014 and having two handles 1016 attached thereto. Bowl 1012 may be made of food-grade plastic; underline 1014 may be made of recycled plastic in the same or a different color than bowl 1012. Handles 1016 may be metalized non-food grade plastic or pigmented during injection-molding. Underliner 1014 may be attached to bowl 1012 by projections 1018 and recesses 1020, and handles 1016 may also be attached by projections 1022 and recesses 1024.

FIG. 12 illustrates a candle holder 1026 made of plastic with a first part 1028 defining a holder and a second part 1030 defining a base. First part 1028 may be injection-molded of plastic in a black pigment and second part 1030 may be metalized in a suitable metallic tone such as a gold metal color. Holder 1028 has a projection 1032 that is received in a hole 1034 to hold holder 1028 to base 1030.

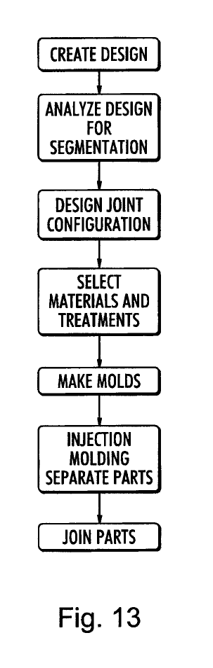

Briefly and as illustrated in FIG. 13, the present method includes the actions of providing a design for cutlery or tableware, defining parts of the cutlery or tableware that are to be separately made parts, determining how the separately made parts will be joined, determining the materials of which the separate parts will be made, determining the treatments to which the separately made parts will be subjected to, providing part molds to make the separate parts, injection-molding the separate parts in the part molds, subjecting any part of the separately made parts to treatment if any, and joining the parts to form the cutlery or tableware.

In the first action of the present method, an external design is obtained or created for a cutlery set or item of tableware. The external design includes a complete specification for the cutlery or tableware, including scale drawings showing the external shape and size and ornamentation that will become a surface feature as well as materials and treatments.

Next the external design is analyzed for the appropriate places for segmentation, that is, the division of the cutlery or tableware into parts, typically two parts but possibly more than two parts. For example, cutlery may be conveniently divided into two parts with the food contacting end being a first part and the handle being the second part. Cutlery may also be divided into three parts with a collar part separating the food-contacting part from the handle part. A dinner plate design may include a central food-contacting portion as a first part and second part defining a ring around the central part. A dinner plate may have a third part defining a second narrow ring surrounding the second part. The precise division would take into consideration aesthetic issues, cost issues, and injection-molding issues, such as a preference for simplification of the mold.

Essentially for cutlery and for tableware, a food contacting part is a first part and all else is a second non-food-contacting parts. For tableware that is not intended for food contact, such as napkin rings or candlestick holders, aesthetic, cost and injection-molding issues for each design may be used to determine the number of parts and the location of each part.

Once the individual parts are designed, the structure for joining the two parts may be defined. The use of the parts and the forces that are appropriate for that use must be considered primarily. The second consideration is whether the joint is temporary or permanent. If the joint is permanent, that is, to be joined once and never taken apart, the design of the joint can be at least as strong as the balance of the cutlery or tableware. If the joint is not permanent, then it will either need to be weaker than the rest of the cutlery or tableware or have a release mechanism to facilitate disassembly. If the joint is to be permanent, the initial manufacturer has more options on the structures and processes for joining the parts, as, for example, the manufacturer may join one part to the other while one is still warm so that it shrinks down onto the other part. However, an intermediate manufacturer may assemble parts made by the initial manufacturer. Although the intermediate manufacturer may not have all the options of the initial manufacturer, it still has many options on structures for joining two parts permanently, including adhesives, friction fitted parts, and snap fits. If the joint is not permanent, it can either be a looser friction fit or a fitting that has a releasable locking mechanism.

The head and handle portions of the cutlery may be connected or assembled together by a variety of construction features and/or mechanisms. For example a cavity may be formed in either the handle or the head as part of the injection-molding process and a corresponding tang formed in the complementing part i.e. in the head or the handle respectively. The cutlery is then assembled by inserting the tang into the cavity. In some embodiments the tang is inserted into the cavity while the handle is still warm so that, as the cavity cools, it shrinks to the size and exact shape of the tang for a more secure fit. In other embodiments, the tang includes at least one shape feature, such as a texture, a groove or a ridge, which increases the frictional grip of the tang within the cavity. In still other embodiments, the tang includes a hook, shoulder, penetration, or other feature which engages with a corresponding feature within the cavity, or which is surrounded by and enveloped within warm plastic as the cavity cools and shrinks around the tang, thereby providing a structural barrier to separation of the head from the handle.

Another action is to determine the type of materials and treatments for all parts of the cutlery and tableware. The choice of materials includes choosing a plastic and its source (recycled or virgin) and grade (food grade or other), whether the plastic will be clear or include a pigment, and whether it will have a surface treatment such as a texture or metallization, and whether it will include additives, such as tiny metal particles in an otherwise clear or translucent plastic or an antimicrobial agent in the plastic or only in a co-extruded plastic layer.

Molds may be made for injection-molding each part as a separate part, including the molding of the joint configurations.

The present method further includes the actions of injection-molding the first part, such as cutlery heads, separately from second part, such as the cutlery handles, and joining the first and second parts together.

It will be understood that the foregoing actions may be performed in different orders than as presented above or some actions may be taken in parallel to and that some may be taken immediately following other actions or may follow later, such as joining the first and second parts may be done well after the parts are injection-molded.

It will be appreciated that the present cutlery be made in many permutations and combinations of styles and colors, including metalized versions, while remaining sufficiently economical to manufacture so as to be cost-effective for disposal following use. This advantage becomes possible because of the use of less-expensive, non-food-grade plastics for the second part, namely, non-food-contacting handles and by a universal joint configuration that enables any of the handles to be interchangeable with any of the heads. In some embodiments of metalized cutlery, this advantage is further enabled by limiting the metallization to only the heads of the cutlery.

Accordingly a manufacturer can stock, say, a dozen different handle designs and colors and several different head designs, some metalized and some in colors, so that customers can select the head style and complementary handle style they deem suitable for a particular event.

Those skilled in the art of cutlery manufacture will appreciate that many substitutions and modifications can be made to the foregoing description of preferred embodiments without departing from the spirit and scope of the invention, which is defined by the appended claims.

1-25. (canceled)

26. A method of making plastic cutlery for use in food service, said cutlery being one or more of a knife, a fork or a spoon, said method comprising the steps of:
a. providing a first part of said cutlery, said first part including a first joint configuration;
b. providing a second part of said cutlery, said second part including a first joint configuration;
c. connecting said first part to said second part by said first and second joint configurations, said first joint configuration different from said second joint configuration, one of first or second joint configurations includes a cavity and the other of said first or second joint configurations includes a tang, at least a portion of said tang positioned in said cavity when said first and second parts are connected together.

27. The method as defined in claim 26, wherein said joint configurations on said first and second parts each have a shape that requires said first and second parts to be oriented with one another is a certain way prior to said joint configurations being joinable together.

28. The method as defined in claim 26, wherein said joint configuration of said second part having a non-circular shaped cavity, said joint configuration of said first part having a non-circular shape that corresponds to said shape of said cavity.

29. The method as defined in claim 27, wherein said joint configuration of said second part having a non-circular shaped cavity, said joint configuration of said first part having a non-circular shape that corresponds to said shape of said cavity.

30. The method as defined in claim 26, wherein said cavity of said joint configuration of said second part including a groove, ridge, or combination thereof, said joint configuration of said first part including a groove, ridge, or combination thereof.

31. The method as defined in claim 29, wherein said cavity of said joint configuration of said second part including a groove, ridge, or combination thereof, said joint configuration of said first part including a groove, ridge, or combination thereof.

32. The method as defined in claim 26, wherein said joint configuration of said first part including a plurality of teeth.

33. The method as defined in claim 31, wherein said joint configuration of said first part including a plurality of teeth.

34. The method as defined in claim 26, wherein said joint configuration of said first part including first and second bendable arms, said arms spaced from one another.

35. The method as defined in claim 26, wherein said joint configuration of said first part including first and second bendable arms, said arms spaced from one another along a portion of said arms and connected together at the end of said arms.

36. The method as defined in claim 26, wherein said joint configuration of said first part and said second part form a friction connection.

37. The method as defined in claim 26, wherein, said joint configuration of said first part and said second part are configured to enable said first and second parts to be separated form one another after said first and second parts are connected together.

38. The method as defined in claim 26, further comprising the step of metalizing said first part.

39. The method as defined in claim 26, wherein said cutlery including said fork and said spoon, said first part of said fork connectable to said second part of said fork and said spoon, said first part of said spoon connectable to said second part of said fork and said spoon.

40. The method as defined in claim 26, including the additional steps of:
(1) selecting a first plastic resin for said first part and a second plastic resin for said second part, said first plastic resin being from a different source of plastic resin than said second plastic resin, said first plastic resin is food grade resin;
(2) injection-molding said first part with said first plastic resin; and,
(3) injection-molding said second part with said second plastic resin.

41. The method as defined in claim 40, wherein said second plastic resin is not food grade resin.

42. The method as defined in claim 40, including the additional step of selecting a pigment for said second part and injection-molding said second part with said selected pigment.

43. The method as defined in claim 40, further comprising the step of impregnating said first resin with an anti-microbial agent before injection-molding said first part.

44. The method as recited in claim 40, further comprising the step of co-extruding said first part with a coating of an anti-microbial agent such that said anti-microbial agent is coated on an outer surface of said first part.

45. The method as recited in claim 26, further comprising the step warming at least one of said first or second joint configurations prior to connecting together said first and second parts and allowing said at least one warmed first or second joint configurations to cool after said first and second parts are connected together to cause one of said first or second joint configurations to shrink down onto the other of said first or second joint configurations.
